(19) United States
(12) Patent Application Publication
(10) Pub. No.: US 2011/0036501 A1
(43) Pub. Date: Feb. 17, 2011

(54) TAPE FEEDING DEVICE AND TAPE PRINTING APPARATUS INCLUDING THE SAME

(75) Inventor: Hideki Sakano, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/839,517

(22) Filed: Jul. 20, 2010

(30) Foreign Application Priority Data
Aug. 12, 2009 (JP) 2009-187153

(51) Int. Cl. B29C 65/50; B32B 41/00

(52) U.S. Cl. 156/350; 156/378

(57) ABSTRACT

A tape feeding device includes: a tape attachment section to which a tape body having a tape core and a tape-shaped material wound around the tape core is detachably attached; a tape feeding unit which feeds the tape-shaped material while drawing the tape-shaped material from the tape core of the tape body attached to the tape attachment section; a rotor which engages with the tape core of the tape body attached to the tape attachment section and rotates in synchronization with the rotation of the tape core rotated when the tape-shaped material is drawn from the tape core; and a rotation detecting unit which detects the rotation condition including rotation stop of the rotor.

The entire disclosure of Japanese Patent Application No. 2009-187153, filed on Aug. 12, 2009, is expressly incorporated by reference herein.

### BACKGROUND

1. Technical Field

The present invention relates to a tape feeding device which draws tape-shaped material wound around a tape core in the shape of roll to feed the tape-shaped material, and a tape printing apparatus including the tape feeding device.

2. Related Art

A known tape feeding device (tape printing apparatus) recognizes the end of a tape-shaped material based on detection of a detection portion formed in the vicinity of the end of the wound tape-shaped material using a photo-sensor (photo-sensor as a detecting unit) provided adjacent to a cutter at a position downstream from a thermal head (see JP-A-08-267881).

According to this type of tape feeding device, the detection portion is provided as a hole (or transparent portion) on the tape-shaped material through which light from the photo-sensor passes. When the photo-sensor detects the detection portion (tape end detection), feeding of the tape-shaped material and printing on the tape-shaped material are both stopped. In this case, the length from the detection portion to the end of the tape-shaped material is determined equivalent to the length (distance) from the detection position of the photo-sensor to the printing position of the thermal head such that printing is not performed without the tape-shaped material supplied to the printing position.

According to this type of tape feeding device, however, the detection portion is needed at the rear end of the tape-shaped material (tape end), which increases the manufacturing cost of the tape-shaped material. Moreover, when the tape-shaped material is transparent or semitransparent, detection of the detection portion by the detecting unit such as the photo-sensor becomes extremely difficult. In this case, there is a possibility that the tape end is not accurately detected. Furthermore, the detecting unit cannot determine whether the tape-shaped material is being fed in an appropriate manner or not. In addition, the detecting unit such as the photo-sensor needs to be positioned on the feeding path of the tape-shaped material, which imposes a limitation on the position of the detecting unit.

### SUMMARY

It is an advantage of some aspects of the invention to provide a tape feeding device capable of securely detecting the tape end of a tape-shaped material and recognizing the feeding condition of the tape-shaped material, and also capable of increasing the degree of freedom in determining the position of a detecting unit. It is another advantage of some aspects of the invention to provide a tape printing apparatus including this tape feeding device.

A tape feeding device according to a first aspect of the invention includes: a tape attachment section to which a tape body having a tape core and a tape-shaped material wound around the tape core is detachably attached; a tape feeding unit which feeds the tape-shaped material while drawing the tape-shaped material from the tape core of the tape body attached to the tape attachment section; a rotor which engages with the tape core of the tape body attached to the tape attachment section and rotates in synchronization with the rotation of the tape core rotated when the tape-shaped material is drawn from the tape core; and a rotation detecting unit which detects the rotation condition including rotation stop of the rotor.

According to this structure, the rotation condition of the tape core including rotation stop is detected by using the rotor. Thus, the condition of the tape-shaped material being drawn and fed can be determined based on the condition of the tape core. For example, whether the tape-shaped material is being drawn and fed in the normal condition or not can be determined based on the detection of the rotation of the rotor in synchronization with the tape feeding unit. In addition, the condition that the tape-shaped material is finished (tape end) and the abnormal feeding condition of the tape-shaped material can be determined based on the detection of rotation stop of the rotor. In this case, a special process indicating the tape end need not be provided on the tape-shaped material. Accordingly, the tape-shaped material (and the tape body as well) can be manufactured at low cost. Moreover, the rotation detecting unit for detecting the rotation condition is only required to be disposed according to the shape and position of the rotor as the detection target. Thus, the position of the rotation detecting unit can be more freely determined, to a certain degree, than a structure which uses the tape-shaped material as the detection target.

It is preferable that the rotor is rotatably supported by the tape attachment section at a position coaxial with the tape core, and that the tape core and the rotor engage with each other by spline engagement.

According to this structure, the rotation of the tape core can be securely transmitted to the rotor. Thus, idling of the tape core and the rotor can be avoided, and accurate detection of the rotation condition of the rotor by the rotation detecting unit can be secured.

It is preferable that the rotor includes a torque limiter which brakes rotation.

According to this structure, the tape-shaped material is wound around the tape core without release of the winding condition, and is fed without looseness with back-tension applied to the tape-shaped material. Thus, the rotation detecting unit can detect the accurate rotation condition.

It is preferable that the tape feeding device includes a control unit which controls operation of the tape feeding unit, and a type detecting unit which detects the type of the attached tape body. The control unit includes a control table storing various parameters for each type of the tape body. The control unit refers to the control table based on the detection result received from the type detecting unit. The control unit calculates the remaining amount of the tape-shaped material based on the feeding speed of the tape feeding unit, the detection result received from the rotation detecting unit, and the reference result obtained from the control table.

According to this structure, the remaining amount of the tape-shaped material can be easily calculated regardless of the structure of the tape-shaped material (such as color and type). Moreover, the user can easily check the replacement time of the tape body and the remaining amount by using a notifying unit.

It is possible to use a correspondence table showing the correlation between the rotation condition of the rotation detecting unit and the remaining amount of the tape-shaped material as the control table. In this case, the remaining amount can be calculated based on the detection result received from the rotation detecting unit only by referring to the control table.

It is preferable that the rotor includes at least a detection portion, and that the rotation detecting unit has a photo-sensor facing the detection portion.

In addition, it is preferable that the rotor includes at least a detection portion, and that the rotation detecting unit has a microswitch which contacts the detection portion to be turned on or off.

According to these cases, the rotation of the rotor can be accurately detected by the simplified structure. Accordingly, the detection of the tape end and the feeding condition of the tape-shaped material and the calculation of the remaining amount of the tape-shaped material can be highly accurately achieved.

A tape printing apparatus according to a second aspect of the invention includes: the tape feeding device described above; and a tape printing unit which performs printing on the tape-shaped material drawn and fed.

When the tape-shaped material is a printing tape in this structure, the drawing condition of the printing tape, that is, whether the printing tape is being fed in the normal condition or not can be accurately determined. Thus, feeding of the tape-shaped material can be automatically stopped based on the detection that the tape-shaped material is finished or that the tape-shaped material is loosened or entangled, for example. Accordingly, problems such as printing failure caused by continuation of the printing process by the tape printing unit without supply of the tape-shaped material can be avoided.

### BRIEF DESCRIPTION OF THE DRAWINGS

The invention will be described with reference to the accompanying drawings, wherein like numbers reference like elements.

FIG. 1 is a perspective view illustrating the external appearance of a tape printing apparatus when a cover of the tape printing apparatus is opened.

FIG. 2 is a plan view of a tape cartridge from which an upper case is cut and removed.

FIG. 3A is a perspective view illustrating a cross section of the tape cartridge taken along a line A-A in FIG. 1.

FIG. 3B is a perspective view illustrating a cross section of a rotor.

FIG. 4 schematically illustrates a tape cartridge according to a first embodiment, wherein: apart (a) is a plan view showing a part of the tape cartridge; and a part (b) is a cross-sectional view of the tape cartridge (including the rotor and others) taken along a line A-A in the part (a).

FIG. 5 is a block diagram showing a control device of the tape printing apparatus.

FIG. 6 shows the relationship between the remaining amount of a printing tape and a rotation detection signal detected by a rotation detecting unit.

FIG. 7 shows respective constants and variables used for calculation of the remaining amount of the printing tape.

FIG. 8 is a cross-sectional view of a tape cartridge, a rotor and others taken along the line A-A in FIG. 1 according to a third embodiment.

FIG. 9 illustrates a rotor of a tape printing apparatus according to a fourth embodiment, wherein: a part (a) is a cross-sectional view; and a part (b) is a bottom view.

FIG. 10A illustrates a rotor of a tape printing apparatus according to a fifth embodiment, wherein: a part (a) is a cross-sectional view; and a part (b) is a bottom view.

FIG. 10B illustrates a rotor of a tape printing apparatus according to a sixth embodiment, wherein: a part (a) is a cross-sectional view; and a part (b) is a bottom view.

### DESCRIPTION OF EXEMPLARY EMBODIMENTS

Embodiments of a tape printing apparatus according to the invention are hereinafter described with reference to the appended drawings. This tape printing apparatus draws a printing tape (tape-shaped material) and an ink ribbon from an attached tape cartridge, performs printing while simultaneously feeding the printing tape and the ink ribbon in tension, and cuts a printed portion of the printing tape into a label (tape piece).

### First Embodiment

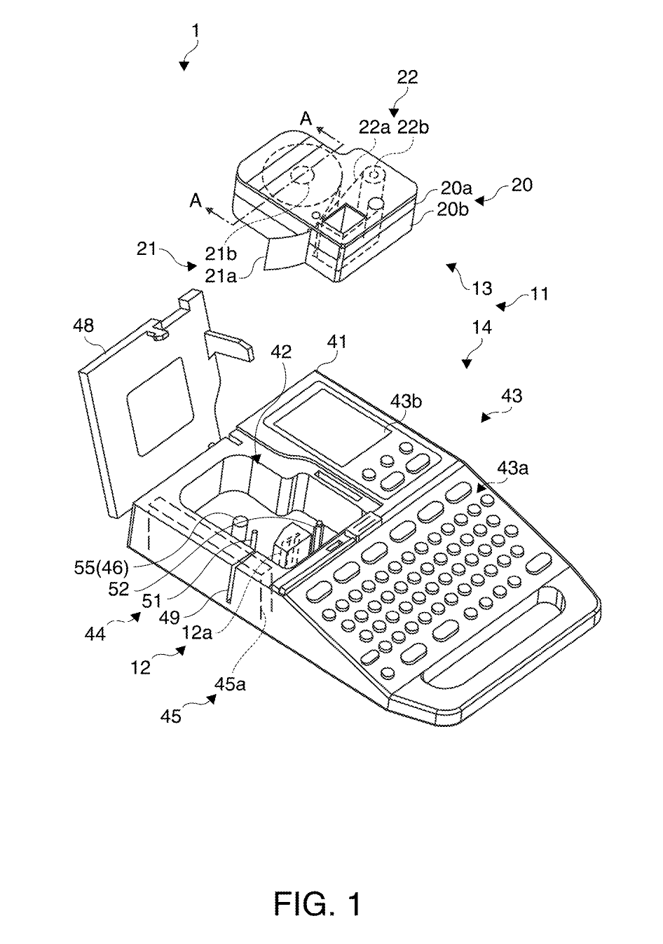

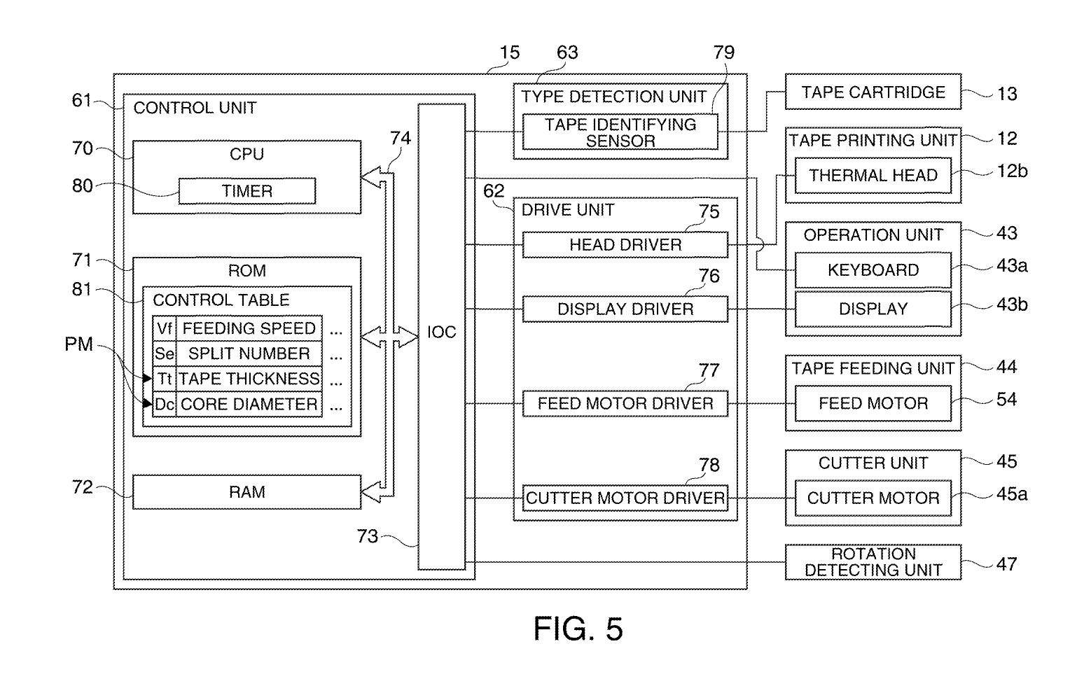

A tape printing apparatus 1 is now described with reference to FIG. 1. FIG. 1 is a perspective view illustrating the external appearance of the tape printing apparatus 1 when a cover of the printing device 1 is opened. The tape printing apparatus 1 includes a tape feeding device 11 having a device main body 14 to which a tape cartridge 13 containing a printing tape 21a and the like is detachably attached, and a tape printing unit 12 which performs printing on the printing tape 21a drawn and fed from the tape cartridge 13. The tape printing apparatus 1 further includes a control device 15 (see FIG. 5) which supervises and controls the printing process and the like.

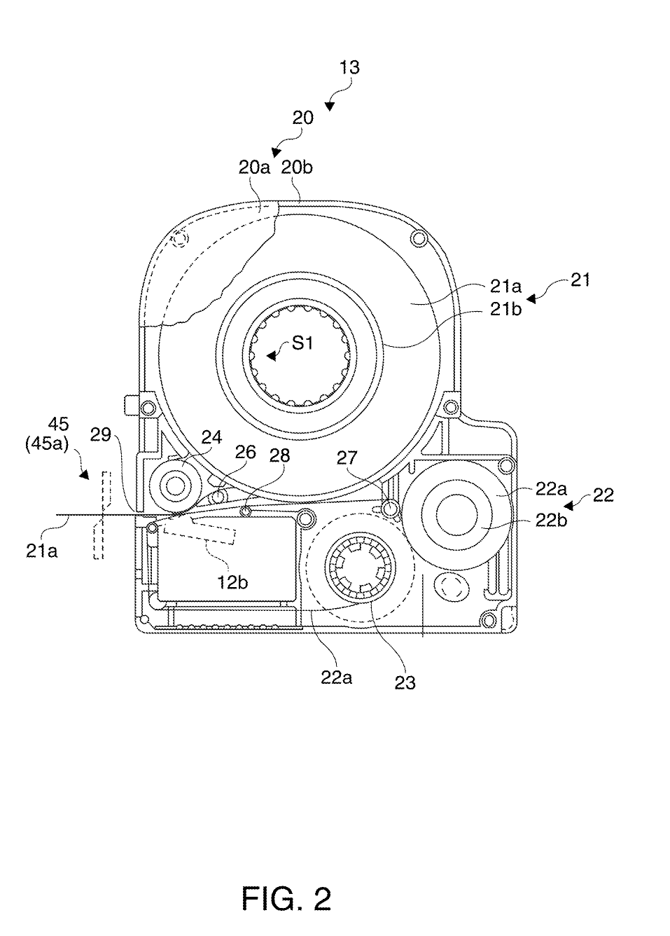

FIG. 2 is a plan view illustrating the tape cartridge from which an upper case 20a is cut and removed. As illustrated in FIGS. 1 and 2, the outer case of the tape cartridge 13 is formed by a resin cartridge case 20 having the upper case 20a and a lower case 20b. The cartridge case 20 of the tape cartridge 13 accommodates a tape body 21 having the printing tape 21a wound around a tape core 21b, a ribbon body 22 having an ink ribbon 22a wound around a ribbon core 22b, a winding core 23 around which the used ink ribbon 22a is wound, and a platen roller 24 which draws the printing tape 21a from the tape body 21 and feeds the printing tape 21a. As can be seen from FIG. 2, the tape body 21 is positioned at the center in the upper area, the ribbon body 22 is positioned on the right side in the lower area, and the winding core 23 is positioned at the center in the lower area. When the tape cartridge 13 is attached to the device main body 14, a thermal head 12a of the tape printing unit 12 is located with respect to the printing tape 21a in such a position as to be opposed to the platen roller 24.

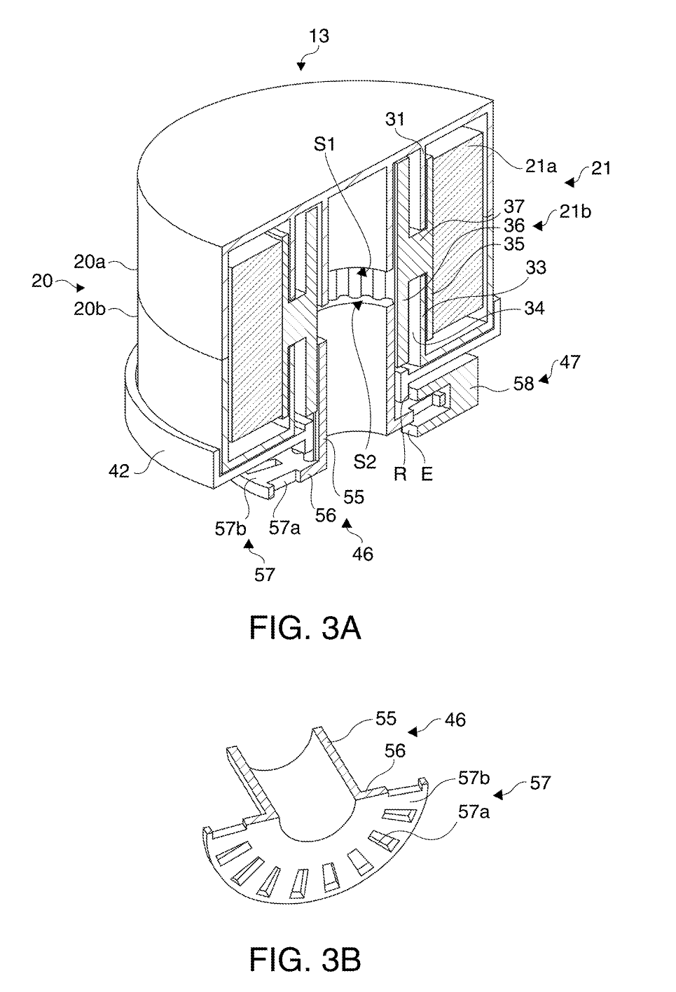

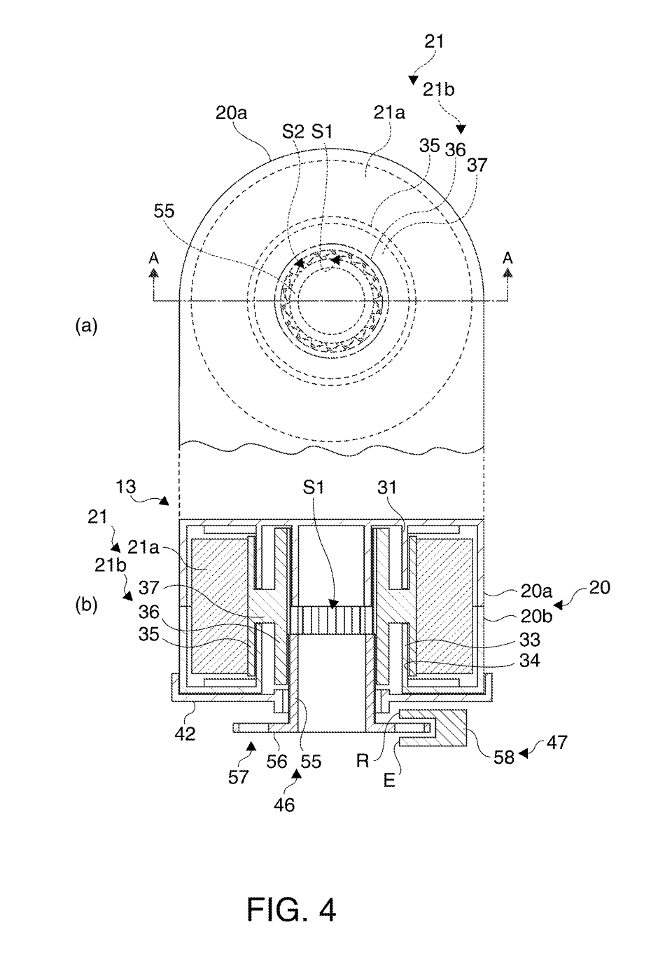

FIG. 3A is a perspective view illustrating a cross section of the tape cartridge 13 taken along a line A-A in FIG. 1, and FIG. 3B is a perspective view illustrating a cross section of a rotor. FIG. 4 schematically illustrates the tape cartridge 13, wherein: a part (a) is a plan view of a part of the tape cartridge 13; and apart (b) is a cross-sectional view of the tape cartridge 13 (including the rotor) taken along a line A-A in the part (a). As can be seen from FIGS. 3A and 3B and FIG. 4, a cylindrical upper core shaft 31 engaging with the tape core 21b projects from the upper case 20a toward the inside. The upper core shaft 31 is formed integrally with the upper case 20a. Similarly, a cylindrical lower core shaft 33 supporting the tape core 21b projects from the lower case 20b toward the inside. The lower core shaft 33 is formed integrally with the lower case 20b and disposed opposite to the upper core shaft 31. A circular detection opening 34 communicating with the device main body 14 is formed inside the lower core shaft 33 to engage with a rotor 46 described later.

Each of the tape core 21b, the ribbon core 22b, and the winding core 23 is a cylindrical component disposed between the upper case 20a and the lower case 20b. Though not shown in the figure, each of the tape core 21b, the ribbon core 22b, and the winding core 23 has a rotation stop mechanism which is released when the tape cartridge 13 is attached to the device main body 14.

The tape core 21b has an outer cylindrical portion 35, an inner cylindrical portion 36, and an annular connecting portion 37 for connecting the outer cylindrical portion 35 and the inner cylindrical portion 36 at an intermediate position, each of the portions 35, 36 and 37 is formed integrally with one another to form a dual cylindrical shape on the whole. The printing tape 21a is wound around the outside surface of the outer cylindrical portion 35. The upper core shaft 31 and the lower core shaft 33 engage with the inside of the outer cylindrical portion 35 such that the annular connecting portion 37 is sandwiched between the upper core shaft 31 and the lower core shaft 33 in the up-down direction.

Spline grooves S1 engaging with the rotor 46 (an engaging shaft 55 of the rotor 46) described later is formed on the inner surface of the inner cylindrical portion 36. The spline grooves S1 allow the tape core 21b to be detachably attached to the rotor 46 in the axial direction and allow the tape core 21b and the rotor 46 to rotate in synchronization with each other.

The printing tape 21a drawn from the tape core 21b is guided by a tape guide pin 26 to reach the platen roller 24. On the other hand, the ink ribbon 22a drawn from the ribbon core 22b is guided toward a first ribbon pin 27 and a second ribbon pin 28 while tensioned to reach the platen roller 24. The ink ribbon 22a having reached the platen roller 24 opposed to the thermal head 12a is subjected to the printing process by the thermal head 12a while being fed with the printing tape 21a overlapped on the ink ribbon 22a. The printing tape 21a after printing is delivered to the outside of the tape cartridge 13 through a tape ejection slot 29 formed on the side surface of the cartridge case 20. The ink ribbon 22a moves around within the cartridge case 20 to be wound around the winding core 23.

The device main body 14 constituting the main part of the tape feeding device 11 is now explained. As illustrated in FIG. 1, the device main body 14 has a device case 41 forming the outer case of the device main body 14, and a cartridge attachment section 42 to which the tape cartridge 13 is attached. The device main body 14 further includes an operation unit 43 having a keyboard 43a as an input device directly operated by a user and a display 43b (notifying unit) which displays the input result and the like received through the keyboard 43a, a tape feeding unit 44 which feeds the printing tape 21a while drawing the printing tape 21a from the tape cartridge 13, a cutter unit 45 which cuts the printing tape 21a after printing, the rotor 46 which engages with the tape core 21b of the tape cartridge 13 attached to the cartridge attachment section 42, and a rotation detecting unit 47 (see FIG. 5) which detects the rotation condition including rotation stop of the tape core 21b by using the rotor 46.

The keyboard 43a is positioned on the front half part of the upper surface of the device case 41, and the display 43b is positioned on the right rear half part of the upper surface of the device case 41. An opening and closing cover 48 is provided on the left rear half part of the upper surface of the device case 41. The cartridge attachment section 42 is concaved inside the opening and closing cover 48. The tape printing unit 12, the tape feeding unit 44, and the rotor 46 are equipped within the cartridge attachment section 42 in such a manner as to be hidden from the appearance. A tape identifying sensor 79 described later (see FIG. 5) is provided at a corner of the cartridge attachment section 42 to identify the type and the like of the cartridge case 20.

The tape feeding unit 44 includes a platen drive shaft 51 for driving the platen roller 24 to feed the printing tape 21a, a winding drive shaft 52 for driving the winding core 23 to wind the ink ribbon 22a, a feed motor 54 (see FIG. 5) for rotating the platen drive shaft 51 and the winding drive shaft 52 in synchronization with each other, and a train of gearings (not shown) for transmitting the driving force of the feed motor 54 to the platen drive shaft 51 and the winding drive shaft 52. The feed motor 54 and the train of gearings are contained in a lower space below the bottom plate of the cartridge attachment section 42.

When the tape cartridge 13 is attached to the cartridge attachment section 42, the platen drive shaft 51 engages with the platen roller 24. Also, the winding drive shaft 52 engages with the winding core 23. Simultaneously, the rotor 46 engages with the tape core 21b, and thermal head 12a contacts the platen roller 24 with the printing tape 21a and the ink ribbon 22a sandwiched between the thermal head 12a and the platen roller 24 to come into print stand-by condition.

A tape ejection slot 49 for connecting the cartridge attachment section 42 and the outside of the device is provided on the left side of the device case 41. The cutter unit 45 (cutter) faces the tape ejection slot 49 to cut the printed part of the printing tape 21a fed through the tape ejection slot 49 in the tape width direction and produce a tape piece (label) by actuation of a cutter motor 45a.

As illustrated in FIGS. 3A and 3B and FIG. 4, the rotor 46 has the engaging shaft 55 engaging with the shaft center of the tape core 21b, and an annular flange 56 provided at the lower end of the engaging shaft 55, as components formed integrally with each other. The engaging shaft 55 is a cylindrical part, while the flange 56 is a flange-shaped part disposed on the circumference of the lower end of the engaging shaft 55. In the rotor 46, the flange 56 is positioned within the lower space below the bottom plate of the cartridge attachment section 42, and the engaging shaft 55 extending upward from the flange 56 projects from the bottom plate of the cartridge attachment section 42. The rotor 46 having this structure is rotatably supported by the cartridge attachment section 42 (the device case 41).

Splines S2 engaging with the spline grooves S1 formed on the inner surface of the inner cylindrical portion 36 are formed on the outer surface of the engaging shaft 55. When the tape cartridge 13 is attached to the cartridge attachment section 42, the engaging shaft 55 engages with the inner cylindrical portion 36 (see FIG. 3A) and rotates in synchronization with the rotation of the tape core 21b rotated for drawing the printing tape 21a. By this method, the accurate rotation condition of the rotor 46, that is, the accurate rotation condition of the tape core 21b can be detected by the rotation detecting unit 47 (the details will be described later). It is preferable that the tips of the splines S2 of the engaging shaft 55 have acute angles for achieving spline engagement by the guide of the acute-angled tips. A structure not having the spline grooves S1 on the inner cylindrical portion 36 nor the splines S2 on the engaging shaft 55 is allowed. According to this structure, the inner cylindrical portion 36 and the engaging shaft 55 engage with each other and rotate in synchronization with each other by the frictional force produced by the engagement. In this case, it is preferable that the engaging shaft 55 is formed by elastic material such as rubber or has a tapered shape which becomes thinner in the upward direction.

The flange 56 has a detection portion 57 as a detection target for the rotation detecting unit 47 described later (see FIG. 3B). The detection portion 57 has a plurality of light transmission portions 57a as rectangular or sectorial openings penetrating the flange 56 in the thickness direction (vertical direction), and a plurality of light shield portions 57b as areas other than the openings disposed alternately and successively. The plural light transmission portions 57a and the plural light shield portions 57b are disposed annularly on the plane of the flange 56 with the same pitch, and pulse signals are produced based on detection of the rotation of the rotor 46 by the rotation detecting unit 47. The provided numbers of the light transmission portions 57a and the light shield portions 57b may be arbitrarily determined as long as at least one for each is provided. In addition, the light transmission portions 57a and the light shield portions 57b are not required to be equipped at equal intervals. That is, it is only required that at least one portion for transmitting light received from the rotation detecting unit 47 or at least one portion for shielding the light is provided as the detection portion 57. The position of the detection portion 57 (the light transmission portions 57a and light shield portions 57b) is not limited to the position on the flange 56 but may be any position as long as the detection portion 57 rotates in accordance with the rotation of the tape core 21b and allows detection of the rotation of the tape core 21b by using the rotation detecting unit 47 described later. For example, the flange 56 may be removed. Instead, the light transmission portions 57a and the light shield portions 57b may be provided on the lower end surface of the engaging shaft 55. Alternatively, only the light shield portions 57b may be projected outwardly or inwardly from the engaging shaft 55. That is, the light transmission portions 57a and the light shield portions 57b are not required to be annularly disposed. Furthermore, when the flange 56 is transparent, a seal (tape) having stripes corresponding to the light transmission portions 57a and the light shield portions 57b may be affixed to the flange 56.

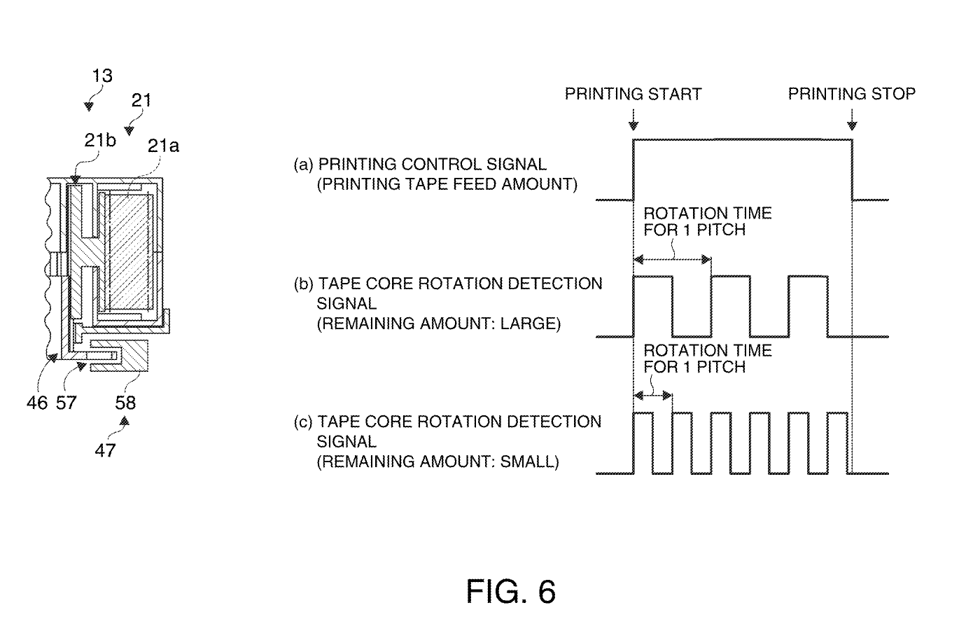

As illustrated in FIGS. 3A and 3B and FIG. 4, the rotation detecting unit 47 is a photo-sensor which detects electromagnetic energy such as light. According to the first embodiment, a transmission type photo-sensor (photo-sensor) 58 having a light emitting element E and a light receiving element R disposed opposite to each other is used as an example of the photo-sensor. The transmission type photo-sensor 58 is a so-called photo-interrupter having a converting circuit which detects the intermittence and intensity of light and converts the detection result into electric signals. The light emitting element E and the light receiving element R of the transmission type photo-sensor 58 are positioned horizontally to face the detection portion 57 of the rotor 46 (the flange 56 of the rotor 46). When the rotor 46 rotates in synchronization with the rotation of the tape core 21b, the transmission type photo-sensor 58 detects output change of voltage produced by the plural light transmission portions 57a and the plural light shield portions 57b of the detection portion 57. This output change is transmitted to the control device 15 to be recognized as pulse signals (rotation detection signals) (see graph (a) and graph (b) in FIG. 6). Based on the pulse signals and pulse signals of the control device 15, the control device 15 determines the rotation condition of the tape core 21b (such as rotation time and circular-arc length). By this method, the control device 15 is allowed to recognize the accurate condition of the printing tape 21a being drawn and fed. When the detection portion 57 is provided not on the flange 56 but on the inside or outside of the engaging shaft 55, the position of the detection portion 57 is changed such that the rotation detecting unit 47 can face the detection portion 57. That is, it is only required that the rotation detecting unit 47 is disposed in accordance with the shape and the position of the rotor 46 as the detection target. Thus, the position of the rotation detecting unit 47 can be more freely determined, to a certain extent, than a structure which provides the detection portion 57 as the detection target on the printing tape 21a.

The control device 15 is now explained with reference to FIG. 5. FIG. 5 is a block diagram of the control device 15 included in the tape printing apparatus 1. The control device 15 has a control unit 61 (control unit) for controlling the respective components of the device main body 14, a drive unit 62 for driving the respective components of the device main body 14, and a type detection unit 63 (type detecting unit) for detecting the type of the tape cartridge 13.

The control unit 61 includes a CPU 70, a ROM 71, a RAM 72, and an IOC (input output controller) 73, all of which are connected with one another via an internal bus 74. The CPU 70 carries out various calculations under a control program contained in the ROM 71 and expanded to the RAM 72. The CPU 70 performs functions such as various process controls by processing input and output of respective signals including printing control signals and rotation detection signals of the tape core 21b (the rotor 46) between the CPU 70 and the respective components of the device main body 14 via the IOC 73. The CPU 70 has a timer 80 for updating the internal time.

The ROM 71 has a control table 81 which stores a feeding speed Vf for feeding the printing tape 21a and the ink ribbon 22a by the tape feeding unit 44, a split number Se of the detection portion 57 (the number of pairs of the light transmission portion 57a and the light shield portion 57b provided in the annular shape), and parameters PM for each of the types of the tape cartridge 13 (or the printing tape 21a). The control table 81 stores the parameters PM including a tape thickness Tt of the printing tape 21a and a core diameter Dc of the tape core 21b (the outer cylindrical portion 35 of the tape core 21b).

When the type of the tape cartridge 13 is detected by the type detection unit 63, the corresponding parameters PM and the like are supplied from the control table 81 to the RAM 72. The CPU 70 calculates a remaining amount Lx of the printing tape 21a contained in the tape cartridge 13 based on the feeding speed Vf of the printing tape 21a and the like, the parameters PM, and the detection result from the rotation detecting unit 47. The feeding speed Vf and the split number Se are fixed values (constants), and the tape thickness Tt and the core diameter Dc are determined for each type of the tape cartridge 13. The details of this method will be described later.

The drive unit 62 includes a head driver 75, a display driver 76, a feed motor driver 77, and a cutter motor driver 78 provided to pass input/output signals received from the control unit 61 to the thermal head 12a, the display 43b, the feed motor 54, and the cutter motor 45a and also to actuate these components.

The type detection unit 63 has the tape identifying sensor 79 (microswitch) disposed at the corner of the cartridge attachment section 42 as discussed above. The tape identifying sensor 79 detects a plurality of detection holes (not shown) formed on the rear surface of the cartridge case 20 and identifies the attachment and the type of the tape cartridge 13 based on the combination (bit pattern) of the plural detection holes.

Detection of the tape end (finish of the printing tape 21a), detection of looseness and the like of the printing tape 21a, and calculation of the remaining amount Lx of the printing tape 21a by using the control device 15 are now described.

The detection of the tape end is initially explained. According to the tape printing apparatus 1 in the first embodiment, the printing tape 21a is drawn from the tape core 21b, and the ink ribbon 22a is drawn from the ribbon core 22b in accordance with the rotations of the platen roller 24 and the winding core 23 as discussed above. Thus, it can be determined whether the printing tape 21a and the like are being drawn and fed in the normal condition based on the detection of the rotation of the tape core 21b, i.e., the rotation of the rotor 46 in synchronization with the feeding operation of the printing tape 21a and the like carried out by the tape printing unit 12. When the printing tape 21a is finished, the printing tape 21a to be drawn does not exist on the tape core 21b. As a result, the rotation of the tape core 21b, and the rotation of the rotor 46 engaging with the tape core 21b both come to stop.

Therefore, the detection of the tape end is performed based on the detection of the rotation condition of the rotor 46 by the rotation detecting unit 47. When the tape end is detected, the CPU 70 stops the operations of the feed motor 54 and thermal head 12a according to the control program, and displays on the display 43b that replacement of the tape cartridge 13 is needed so as to notify the user about this fact. Since the printing tape 21a is fed while tensioned and sandwiched between the thermal head 12a and the platen roller 24, the printing tape 21a slightly idles by inertia after the printing tape 21a is finished. Thus, the detection of the tape end may be performed based on the detection of idling of the rotor 46.

By this method, the tape end can be accurately detected by using the rotor 46 without providing a special process on the printing tape 21a to indicate the tape end. Thus, the printing tape 21a (and the tape body 21 as well) can be manufactured at low cost. Moreover, since the operation of the feed motor 54 and the like is stopped before the printing tape 21a is finished, execution of the printing operation under the condition that the printing tape 21a does not exist between the thermal head 12a and the platen roller 24 (printing position) can be avoided. The information that the printing tape 21a is being fed in the normal condition may be displayed on the display 43b as well as the tape end. In addition, the time period from the detection of the tape end to the stop of the feed motor 54 and the like may be prolonged so as to use the largest possible part of the printing tape 21a.

The detection of looseness and the like of the printing tape 21a is now explained. When the printing tape 21a wound around the tape core 21b is loosened or cut, or when the printing tape 21a is loosened or entangled in the course from the tape core 21b to the thermal head 12a for some reasons, for example, the rotor 46 does not rotate for a short period or does not rotate at all after the start of operation of the feed motor 54, that is, the printing tape 21a comes into an abnormal feeding condition.

For solving this problem, the tape printing apparatus 1 according to the first embodiment establishes a predetermined time for detecting looseness and the like (stores the predetermined time in the ROM 71), and determines that the printing tape 21a is in the abnormal feed condition when detecting the rotation of the rotor 46 before the elapse of the predetermined time from the start of operation of the feed motor 54. In this case, the CPU 70 stops the operation of the feed motor 54 according to the control program, and displays the information about the abnormal condition on the display 43b to notify the user about the information. By this method, the user having received this information can check whether the printing tape 21a within the tape cartridge 13 is loosened or in other abnormal condition. When the problems such as looseness of the printing tape 21a produce no obstacle to printing or the like, the operation stop of the feed motor 54 and the display on the display 43b are not required. However, when the predetermined time discussed above is set, the abnormal feeding condition of the printing tape 21a produced by looseness or the like of the printing tape 21a is not erroneously detected as the tape end.

Concerning the detection of the tape end explained above, the case in which the rotation is stopped during the rotation of the rotor 46 (the tape core 21b) (during feeding of the printing tape 21a) has been discussed. However, when the tape cartridge 13 containing the finished printing tape 21a is accidentally attached, for example, this condition can be detected as the tape end based on the fact that the rotation is not detected after the elapse of the predetermined time.

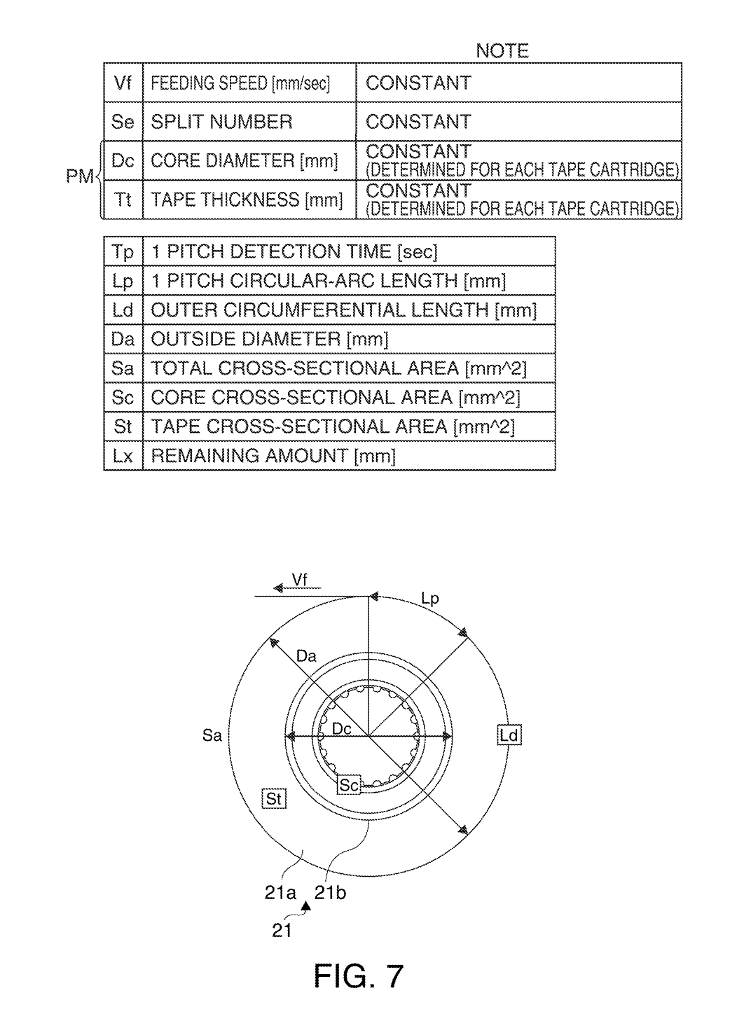

The calculation of the remaining amount Lx of the printing tape 21a is now explained with reference to FIGS. 6 and 7. FIG. 6 shows the relationship between the remaining amount Lx of the printing tape 21a and the rotation detection signal detected by the rotation detecting unit 47. FIG. 7 shows respective constants and variables used for the calculation of the remaining amount Lx of the printing tape 21a. According to the tape printing apparatus 1 in the first embodiment, the feed amount of the printing tape 21a (peripheral speed of the tape body 21 (see graph (a) in FIG. 6)) is constant as shown in FIG. 6. However, the rotation speed of the tape core 21b decreases when the remaining amount Lx is large (see graph (b) in FIG. 6), and the rotation speed of the tape core 21b increases when the remaining amount Lx is small (see graph (c) in FIG. 6). That is, the rotation speed of the tape core 21b is inversely proportional to the diameter of the tape body 21 (outside diameter Da). Accordingly, the tape printing apparatus 1 in the first embodiment calculates the remaining amount Lx of the printing tape 21a from pulse signals (rotation detection signals) and the like detected by the rotation detecting unit 47 based on the inversely proportional relationship between the rotation speed of the tape core 21b and the outside diameter Da of the tape body 21.

Initially, when the rotation detecting unit 47 detects the rotations of the tape core 21b and the rotor 46 after the start of the printing process on the printing tape 21a, the CPU 70 measures a time required for the rotation for each one pitch of the detection portion 57 (the combined length of the one light transmission portion 57a and the one light shield portion 57b: 1 pulse) as a time hereinafter referred to as 1 pitch detection time Tp by using the timer 80 provided on the CPU 70. The 1 pitch detection time Tp is temporarily stored in the RAM 72. Then, the CPU 70 calculates the remaining amount Lx of the printing tape 21a from the feeding speed Vf, the split number Se, and the respective parameters PM (tape thickness Tt and core diameter Dc) read from the 1 pitch detection time Tp and the control table 81 and supplied to the RAM 72.

The specific calculation steps are now explained with reference to FIG. 7. Initially, the circular-arc length of the tape body 21 for the rotation of 1 pitch (hereinafter referred to as 1 pitch circular-arc length Lp) is calculated from the feeding speed Vf and the 1 pitch detection time Tp (see Equation (1)). Then, an outer circumferential length Ld of the tape body 21 at the corresponding time is calculated from the 1 pitch circular-arc length Lp and the split number Se (see Equation (2)), and the outside diameter Da of the tape body 21 at the corresponding time is calculated from the outer circumferential length Ld (see Equation (3)).

Lp=Vf×Tp (1)

Ld=Lp×Se (2)

Da=Ld/π (3)

Next, a total cross-sectional area Sa of the tape body 21 is calculated from the obtained outside diameter Da of the tape body 21 (see Equation (4)). Similarly, the cross-sectional area of the tape core 21b (hereinafter referred to as core cross-sectional area Sc) is calculated from the core diameter Dc (see Equation (5)). Then, the cross-sectional area of the printing tape 21a wound around the tape core 21b (hereinafter referred to as tape cross-sectional area St) is calculated from the difference between the total cross-sectional area Sa and the core cross-sectional area Sc (see Equation (6)). Finally, the remaining amount Lx of the printing tape 21a is calculated from the obtained tape cross-sectional area St and the tape thickness Tt (see Equation (7)).

Sa=(Dâ2)×π/4 (4)

Sc=(Dĉ2)×π/4 (5)

St=Sa−Sc (6)

Lx=St/Tt (7)

After the remaining amount Lx of the printing tape 21a is calculated, the CPU 70 displays the result on the display 43b to notify the user about this information. By this method, the user can check the information and determine whether the tape cartridge 13 needs to be replaced or not according to the necessary length of the printing tape 21a before the printing tape 21a is finished. The remaining amount Lx may be displayed on the display 43b by indicator display as well as numerical display.

According to the example discussed above, the core cross-sectional area Sc is calculated from the core diameter Dc determined for each type of the tape cartridge 13 stored in the control table 81. However, the core cross-sectional area Sc for each type of the tape cartridge 13 may be stored in place of the core diameter Dc. In addition, while the display 43b is used for notifying the user about the information on the printing tape 21a (tape end, looseness and others, and remaining amount Lx) in the first embodiment, a warning lamp such as LED, warning sound from a speaker or the like may be employed for the notification.

### Second Embodiment

It is possible to calculate the remaining amount Lx of the printing tape 21a not by the calculation method according to the first embodiment but from the rotation speed of the rotor 46 (the tape core 21b). More specifically, the 1 pitch length (distance) of the detection portion 57, and the correspondence table showing the correlation between the rotation speed of the tape core 21b for each type of the tape cartridge 13 and the remaining amount Lx at the corresponding rotation speed are stored in the control table 81 in place of the feeding speed Vf, the split number Se, and the respective parameters PM (tape thickness Tt and core diameter Dc). The CPU 70 calculates the rotation speed of the tape core 21b from the 1 pitch length and the 1 pitch detection time Tp, and obtains the corresponding remaining amount Lx based on the calculation result by referring to the control table 81 (correspondence table). Thus, the remaining amount Lx can be easily calculated based on the detection result from the rotation detecting unit 47 only by referring to the control table 81 (correspondence table). Other structures are similar to those in the first embodiment, and the same explanation is not repeated.

According to the first and second embodiments, it is accurately determined whether the printing tape 21a is being fed in the normal condition. Thus, supply of the printing tape 21a can be automatically stopped by detection of the condition that the printing tape 21a is finished, the looseness and entanglement of the printing tape 21a, and other conditions. Accordingly, the problems such as continuation of the printing process by the tape printing unit 12 without supply of the printing tape 21a can be avoided. In addition, the position of the rotation detecting unit 47 can be freely determined to some extent, which increases the degree of freedom in designing the tape printing apparatus 1.

### Third Embodiment

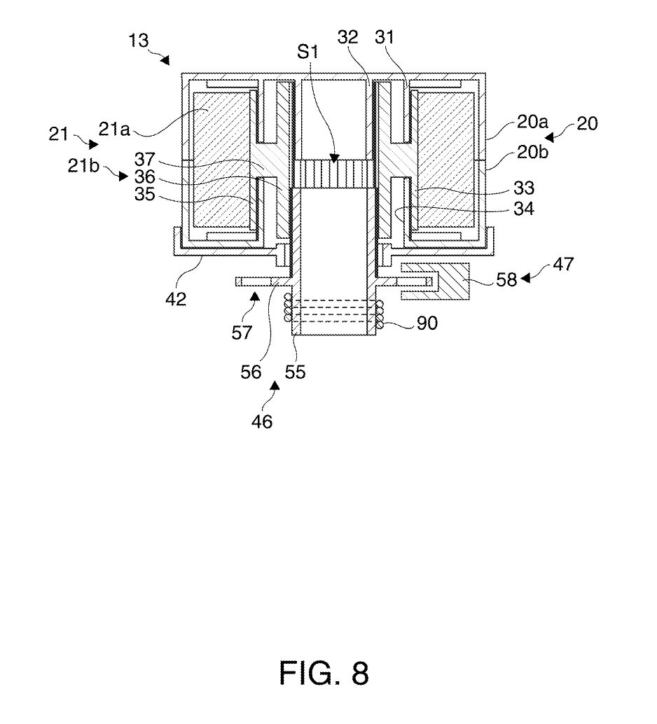

The tape printing apparatus 1 according to a third embodiment is now described with reference to FIG. 8. FIG. 8 is a cross-sectional view of the tape cartridge 13, the rotor 46 and others in the third embodiment taken along the line A-A in FIG. 1. When the printing tape 21a wound around the tape core 21b is loosened, the rotations of the tape core 21b and the rotor 46 cannot be accurately detected as explained above. For solving this problem, the tape printing apparatus 1 in the third embodiment includes a torque limiter 90 for limiting the rotation of the rotor 46.

According to this structure, the engaging shaft 55 of the rotor 46 is extended to a position below the flange 56. That is, the flange 56 is provided at a position slightly lower than the axial center of the engaging shaft 55. The torque limiter 90 is a so-called torsion coil spring wound and slightly fastened around the engaging shaft 55 below the flange 56. The torque limiter 90 gives a braking force to the rotor 46 in the direction opposite to the drawing direction (feeding direction) of the printing tape 21a. This structure allows the printing tape 21a to be fed without looseness with back tension applied thereto, thereby preventing release of the winding condition of the printing tape 21a. Thus, the rotation detecting unit 47 can detect the accurate rotation condition. The torque limiter 90 is not limited to the torsion coil spring but may be other component as long as it can maintain the winding condition of the printing tape 21a wound around the tape core 21b. For example, the torque limiter 90 may be a disk spring disposed between the device case 41 and the lower end of the rotor 46. Other structures are similar to those in the first embodiment, and the same explanation is not repeated. The torque limiter 90 may be provided on the ribbon core 22b around which the ink ribbon 22a is wound. In this case, the ink ribbon 22a is supplied with back tension applied similarly to the third embodiment, and thus the winding condition of the ink ribbon 22a is not loosened.

### Fourth Embodiment

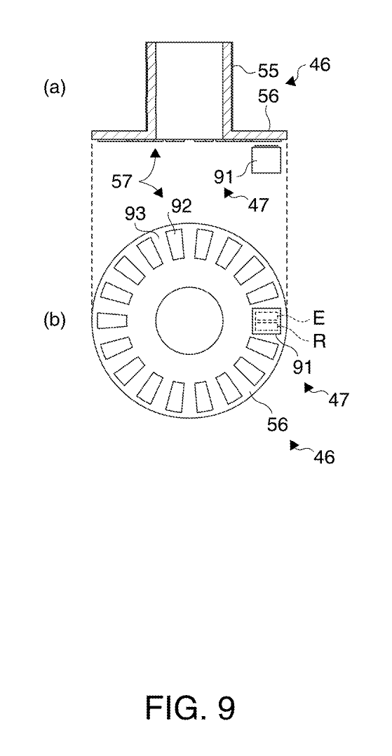

The tape printing apparatus 1 according to a fourth embodiment is now described with reference to FIG. 9. FIG. 9 illustrates the rotor 46 included in the tape printing apparatus 1 in the fourth embodiment, wherein: a part (a) is a cross-sectional view; and a part (b) is a bottom view. The tape printing apparatus 1 according to the fourth embodiment includes a reflection type photo-sensor (photo-sensor) 91 having the light emitting element E and the light receiving element R disposed in the same direction as a photo-sensor constituting the rotation detecting unit 47. The light emitting element E emits light toward the detection portion and the light receiving element R receives the light reflected by the detection portion 57 so that the reflection type photo-sensor 91 detects the intermittence and intensity of the light. In the fourth embodiment, the reflection type photo-sensor 91 is disposed in such a position as to face the lower surface of the flange 56 of the rotor 46. In accordance with this structure, the detection portion 57 in the fourth embodiment has a plurality of light reflection portions 92 which reflect light emitted from the light emitting element E and a plurality of light non-reflection portions 93 which prevent reflection of the light from the light emitting element E disposed alternately and successively on the lower surface of the flange 56 at equal intervals and in the annular shape (see the part (b) in FIG. 9). When the rotor 46 rotates, the light emitted from the light emitting element E of the reflection type photo-sensor 91 and not reflected by the areas of the light non-reflection portions 93 changes output from the reflection type photo-sensor 91, thereby allowing detection of the rotation condition of the rotor 46 (the tape core 21b) (acquirement of pulse signals). The conditions of the detection portion 57 (the light reflection portions 92 and the light non-reflection portions 93) in the fourth embodiment such as the provided number and intervals are arbitrarily determined similarly to the first embodiment. That is, it is only required that at least one area reflecting the light from the rotation detecting unit 47 or one area not reflecting the light from the rotation detecting unit 47 is provided. The position of the detection portion 57 (the light reflection portions 92 and the light non-reflection portions 93) is not limited to the position on the flange 56 but may be any position as long as the detection portion 57 rotates in accordance with the rotation of the tape core 21b and allows detection of the rotation of the rotor 46 by using the rotation detecting unit 47. That is, the light reflection portions 92 and the light non-reflection portions 93 are not required to be disposed in the annular shape. The conditions of the light reflection portions 92 and the light non-reflection portions 93 such as shape and the material may be arbitrarily determined. Other structures are similar to those in the first embodiment, and the same explanation is not repeated.

### Fifth and Sixth Embodiments

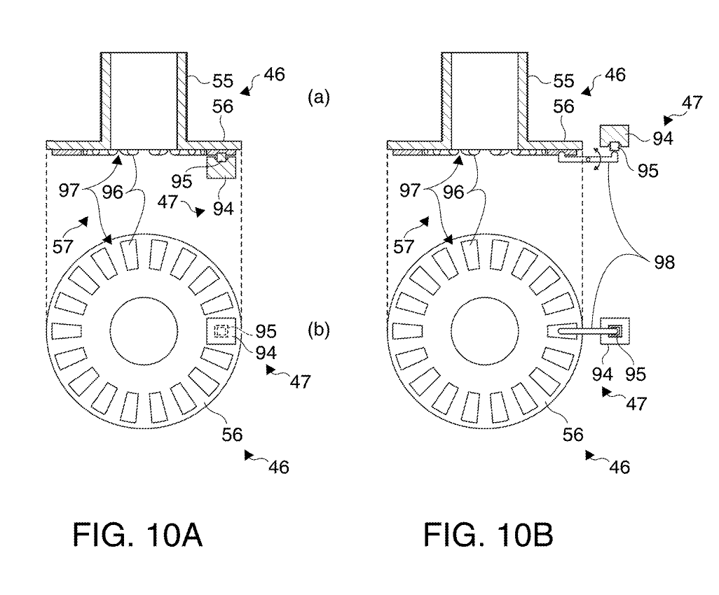

The tape printing apparatus 1 according to fifth and sixth embodiments is now described with reference to FIGS. 10A and 10B. FIG. 10A illustrates the rotor 46 included in the tape printing apparatus 1 in the fifth embodiment, wherein: apart (a) is a cross-sectional view; and apart (b) is a bottom view. FIG. 10B illustrates the rotor 46 included in the tape printing apparatus 1 in the sixth embodiment, wherein: a part (a) is a cross-sectional view; and a part (b) is a bottom view. According to the tape printing apparatus 1 in the fifth embodiment illustrated in FIG. 10A, the rotation detecting unit 47 has a microswitch 94 facing the lower surface of the flange 56 of the tape core 21b. In accordance with this structure, the detection portion 57 in the fifth embodiment has convexes 96 for pushing (turning on) a switch end 95 of the microswitch 94 and concaves 97 for releasing (turning off) the push of the switch end 95 disposed alternately and successively on the lower surface of the flange 56 at equal intervals in the annular shape (see part (a) in FIG. 10A). The microswitch 94 is disposed in such a position as to bring the switch end 95 for switching between on and off of the microswitch 94 into contact with the convexes 96. When the rotor 46 rotates, the convexes and the concaves 97 switch between on and off of the microswitch 94, allowing detection of the rotation condition of the rotor 46 (the tape core 21b) (acquirement of pulse signals). The detection portion 57 may have rectangular (or sectorial) openings in place of the convexes 96 and the concaves 97 similarly to the first embodiment. Alternatively, the wave-shaped convexes 96 and concaves 97 may be provided on the lower end surface of the engaging shaft 55 from which the flange 56 is removed (either example is not shown). The conditions of the convexes 96 and concaves 97 such as the provided number and intervals are arbitrarily determined as long as at least one for each is provided. That is, it is only required that the detection portion 57 has at least the area for pushing the switch end 95 or the area for releasing the push of the switch end 95 is provided. The position of the detection portion 57 (the convexes 96 and the concaves 97) is not limited to the position on the flange 56 but may be other position as long as the rotation of the rotor 46 can be detected. That is, the convexes 96 and the concaves 97 are not required to be disposed in the annular shape. The conditions of the convexes 96 and the concaves 97 such as shape and the material may be arbitrarily determined. Other structures are similar to those in the first embodiment, and the same explanation is not repeated.

According to the tape printing apparatus 1 in the sixth embodiment shown in FIG. 10B, the rotation detecting unit 47 has the microswitch 94, and the detection portion 57 has the convexes 96 and the concaves 97 similarly to the fifth embodiment. However, turning on and off of the microswitch 94 is switched not by direct contact between the switch end 95 of the microswitch 94 and the convexes 96 but by using a pivot member 98. The microswitch 94 is disposed in such a condition that the switch end 95 faces downward and is leveled with the lower surface of the flange 56 (see part (a) in FIG. 10B).

The pivot member 98 is a bar-shaped member which pivots around its center as the movement axis. The upper end of the pivot member 98 is so structured as to contact the convexes 96, and the lower end of the pivot member 98 is so structured as to contact the switch end 95. When the rotor 46 rotates, the pivot member 98 moves in accordance with the shapes of the convexes 96 and the concaves 97, thereby repeating push and release of the switch end 95. By this method, turning on and off of the microswitch 94 can be switched without direct contact between the switch end 95 of the microswitch 94 and the convexes 96. Accordingly, malfunction and failure caused by abrasion of the switch end 95 can be prevented. The rotation detecting unit 47 (microswitch 94) in the sixth embodiment is not required to be disposed at the position in this example but may be located such that the switch end 95 of the microswitch 94 faces upward, for example. Other structures are similar to those in the first embodiment, and the same explanation is not repeated.

According to the third through sixth embodiments, the rotation of the tape core 21b can be accurately detected by using the rotor 46 similarly to the other embodiments. Thus, the detection of the feeding condition and the tape end of the printing tape 21a and the calculation of the remaining amount Lx of the printing tape 21a can be highly accurately achieved. The structures in the fourth through sixth embodiments may include the torque limiter 90 similarly to the third embodiment.

While the detection of the tape end of the printing tape 21a, the detection of looseness and the like of the printing tape 21a, and the calculation of the remaining amount Lx are performed based on detection of the rotation of the tape core 21b in the first through sixth embodiments, these steps may be carried out based on detection of the rotation of the ribbon core 22b. That is, a “tape-shaped material” in the appended claims is not limited to the printing tape 21a but may be the ink ribbon 22a or other tape-shaped materials.

What is claimed is:

1. A tape feeding device comprising:
a tape attachment section to which a tape body having a tape core and a tape-shaped material wound around the tape core is detachably attached;
a tape feeding unit which feeds the tape-shaped material while drawing the tape-shaped material from the tape core of the tape body attached to the tape attachment section;
a rotor which engages with the tape core of the tape body attached to the tape attachment section and rotates in synchronization with the rotation of the tape core rotated when the tape-shaped material is drawn from the tape core; and
a rotation detecting unit which detects the rotation condition including rotation stop of the rotor.

2. The tape feeding device according to claim 1, wherein:
the rotor is rotatably supported by the tape attachment section at a position coaxial with the tape core; and
the tape core and the rotor engage with each other by spline engagement.

3. The tape feeding device according to claim 1, wherein the rotor includes a torque limiter which brakes rotation.

4. The tape feeding device according to claim 1, further comprising:
a control unit which controls operation of the tape feeding unit; and
a type detecting unit which detects the type of the attached tape body,
wherein
the control unit includes a control table storing various parameters for each type of the tape body,
the control unit refers to the control table based on the detection result received from the type detecting unit, and
the control unit calculates the remaining amount of the tape-shaped material based on the feeding speed of the tape feeding unit, the detection result received from the rotation detecting unit, and the reference result obtained from the control table.

5. The tape feeding device according to claim 1, wherein:
the rotor has at least a detection portion; and
the rotation detecting unit has a photo-sensor facing the detection portion.

6. The tape feeding device according to claim 1, wherein:
the rotor has at least a detection portion; and
the rotation detecting unit has a microswitch which contacts the detection portion to be turned on or off.

7. A tape printing apparatus comprising:
the tape feeding device according to claim 1; and
a tape printing unit which performs printing on the tape-shaped material drawn and fed.
